(19) United States
(12) Patent Application Publication
(10) Pub. No.: US 2025/0189110 A1
(43) Pub. Date: Jun. 12, 2025

(54) MATRIX LED SPOTLIGHTS AND METHOD FOR CONTROLLING A LIGHT-GENERATING ASSEMBLY OF A MATRIX LED SPOTLIGHT

(71) Applicant: Arnold & Richter Cine Technik GmbH & Co. Betriebs KG, Munchen (DE)

(72) Inventor: Erwin Melzner, Frasdorf (DE)

(21) Appl. No.: 18/967,764

(22) Filed: Dec. 4, 2024

(30) Foreign Application Priority Data
Dec. 8, 2023 (DE) 102023134437.4

(51) Int. Cl. F21V 23/00; F21Y 105/14; F21Y 113/17; F21Y 115/10; H05B 45/10; H05B 45/20; H05B 47/175; H05B 47/18

(52) U.S. Cl. CPC F21V 23/005; H05B 45/10; H05B 45/20; H05B 47/184; H05B 47/196; F21Y 2105/14; F21Y 2113/17; F21Y 2115/10

(57) ABSTRACT

A matrix light-emitting diodes (LED) spotlight and method of controlling same. The matrix LED spotlight comprises a light-generating assembly comprising a carrier on which a matrix of LEDs is arranged, an LED control device which is coupled to the light-generating assembly and is designed to control the matrix of LEDs individually to emit light on the basis of a matrix-resolved image information stream, and a control information generator. The control information generator is coupled to the LED control device and has a first input interface for feeding in lighting parameters and a second input interface for feeding in user-generated adjustment commands for adjusting lighting parameters fed in via the first input interface for generating the matrix-resolved image information stream.

### FIELD OF THE INVENTION

The present invention relates to a matrix LED spotlight and to a method for controlling a light-generating assembly of a matrix LED spotlight.

Matrix LED spotlights within the meaning of the present disclosure are spotlights which have a plurality of light-emitting diodes (LEDs) arranged in a matrix form as the basic lighting means.

### GENERAL BACKGROUND

Lights comprising light sources arranged in a matrix are modern lighting devices in the field of professional lighting applications. These are lights capable of generating a field of shining and individually controllable pixels and projecting them into the distance on the basis of different technologies. Examples of this are matrix lights in modern motor vehicles based on discrete or monolithic LED arrays, projectors comprising built-in LED light units, LCD displays, laser projectors or combinations of functions of this type, as disclosed in DE 10 2015 012 021 A1.

Matrix LED lights are also used in the event, cinema or theatre sector, since lights of this type are capable of providing large-scale illumination of a film, studio or theatre setup in a wide range of ways. Examples of this are disclosed in U.S. Pat. No. 7,178,941 B2, U.S. Pat. No. 7,522,211 B2, U.S. Pat. No. 5,752,766 A and US 2009/0190346 A1. Lights of this type usually have projection optics capable of projecting the individual pixels onto distant objects with as few distortions and color errors as possible. Depending on the intended use, the lights have more or fewer pixels, more or less luminous flux, and different apertures and outputs.

### SUMMARY OF THE INVENTION

One of the aims of the present invention is to make it possible to set dynamic effects such as the change in a beam characteristic, a position of a light cone, a color temperature or a half-beam angle, an illuminance or other parameters commonly used in lighting technology for a matrix LED spotlight, in particular in the event, studio, cinema or theatre sector, in a simpler, more convenient manner and in real time or almost real time.

This and other objects are achieved by the subject matter of each of the independent claims. Advantageous embodiments are described in the dependent claims which are associated with the independent claims.

In a first aspect of the invention, a matrix LED spotlight comprises a light-generating assembly comprising a carrier on which a matrix of light-emitting diodes (LEDs) is arranged, an LED control device which is coupled to the light-generating assembly and is designed to control the matrix of LEDs individually to emit light on the basis of a matrix-resolved image information stream, and a control information generator. The control information generator is coupled to the LED control device. The control information generator also has a first input interface for feeding in lighting parameters and a second input interface for feeding in user-generated adjustment commands for adjusting lighting parameters fed in via the first input interface to generate the matrix-resolved image information stream.

In a second aspect of the invention, a method for controlling a light-generating assembly of a matrix LED spotlight, which has a carrier on which a matrix of light-emitting diodes (LEDs) is arranged, comprises the steps of:
receiving lighting parameters via an LED control device first input interface of a control information generator;
receiving user-generated adjustment commands for adjusting the lighting parameters fed in via the first input interface via a second input interface of the control information generator;
converting the adjusted lighting parameters by way of the control information generator into a matrix-resolved image information stream; and
controlling the individual LEDs of the matrix of LEDs to emit light on the basis of the matrix-resolved image information stream.

One of the central ideas of the invention is to make possible targeted settings of parameters commonly used in lighting technology, such as color temperature or half-beam angle, without restrictions and in a user-friendly manner by means of a targeted input of user-generated adjustment commands for adjusting lighting parameters, which are entered as lighting data to an LED control device of a matrix LED spotlight. The user-generated adjustment commands make precise implementation of lighting parameters possible, such as the setting of a target value of a specific illuminance in lux on a target surface. In addition, typical dynamic effects, such as the change in a beam characteristic, the change in the position of a light cone or the like, can be implemented directly and without the need for pre-calculation measures via the LED control device, without the need for them to be taken into account in the lighting data with a lead time.

In some embodiments of the first aspect of the invention, the matrix LED spotlight may further comprise a feedback device which is coupled to the control information generator and is designed to detect the light emitted by the light-generating assembly and, on the basis of the detected light, to send a feedback signal to the control information generator for calibrating the matrix-resolved image information stream. In particular, a physical device on site comprising the required interfaces may be used as the feedback device.

Alternatively, the feedback signal may also be fed back via remote access, for example via wireless transmission from a cloud environment. The feedback device can be operated both online and offline. In the former case, for example, sensors can measure physical parameters of the light emitted by the light-generating assembly and transmit them to cloud-based management software, which then in turn sends correspondingly calculated or adjusted correction and/or calibration data back to the control information generator. In the latter case, measurement data from sensors can be stored locally, and a user can use a removable storage medium such as a USB stick or a flash memory to retrieve the stored measurement data at a subsequent time and later feed it back into the control information generator.

In some further embodiments of the first aspect of the invention, the matrix-resolved image information stream may comprise static image information or dynamic video information which specifies the lighting behavior of the individual LEDs of the matrix over time.

In some further embodiments of the first aspect of the invention, the first input interface may be a DMX interface, an RDM interface, an ArtNet interface or an ACN interface. An RS-485 interface, a USB interface, an Ethernet interface or a wireless interface such as WLAN or Bluetooth may be used as the input interface, via which the lighting parameters can be transmitted according to one of the above data coding protocols, i.e. DMX, RDM, ArtNet or ACN.

In some further embodiments of the first aspect of the invention, the matrix LED spotlight may further comprise a user control device which is coupled to the control information generator via the second input interface and has mechanical and/or electronic control elements for a user.

In some further embodiments of the first aspect of the invention, the lighting parameters may include a radiation characteristic, a brightness, a brightness gradient, a two-dimensional light distribution shape, a color, a color gradient and/or a color correction.

In some further embodiments of the first aspect of the invention, the light-generating assembly may further comprise projection optics designed to project the emitted light of each individual LED onto objects in the far field without distortion or color errors.

In some embodiments of the second aspect of the invention, the method may further comprise steps of detecting the light emitted by the light-generating assembly and sending a feedback signal for calibrating the matrix-resolved image information stream to the control information generator on the basis of the detected light.

In some further embodiments of the second aspect of the invention, the matrix-resolved image information stream may comprise static image information or dynamic video information which specifies the lighting behavior of the individual LEDs of the matrix over time.

### BRIEF DESCRIPTION OF THE DRAWINGS

The invention will be described in greater detail with reference to exemplary embodiments illustrated in the accompanying drawings. The accompanying drawings are included to provide further understanding of the present invention and are incorporated into and constitute a part of the present specification. The drawings illustrate embodiments of this invention and, together with the description, serve to explain the principles of the invention. Other embodiments of the present invention and many of the intended advantages of the present invention will be readily understood when clarified by reference to the following detailed description. The elements of the drawings are not necessarily drawn to the same scale as one another. Like reference signs denote correspondingly similar parts.

FIG. 1 schematically illustrates the structure of a matrix LED spotlight according to an exemplary embodiment of the invention; and

FIG. 2 schematically illustrates a flow chart of a method for controlling a light-generating assembly of a matrix LED spotlight according to another exemplary embodiment of the invention.

In the drawings, like reference signs denote like or functionally similar components unless stated otherwise. All directional indications such as “top”, “bottom”, “left”, “right”, “above”, “below”, “horizontal”, “vertical”, “rear”, “front” and similar terms are used for explanatory purposes only and are not intended to limit the embodiments to the specific arrangements shown in the drawings.

### DETAILED DESCRIPTION OF SOME EMBODIMENTS OF THE INVENTION

Although specific embodiments have been illustrated and described herein, it will be appreciated by those of ordinary skill in the art that a variety of alternative and/or equivalent implementations may be substituted for the specific embodiments shown and described without departing from the scope of the present invention. In general, this application is intended to cover any adaptations or variations of the specific embodiments described herein.

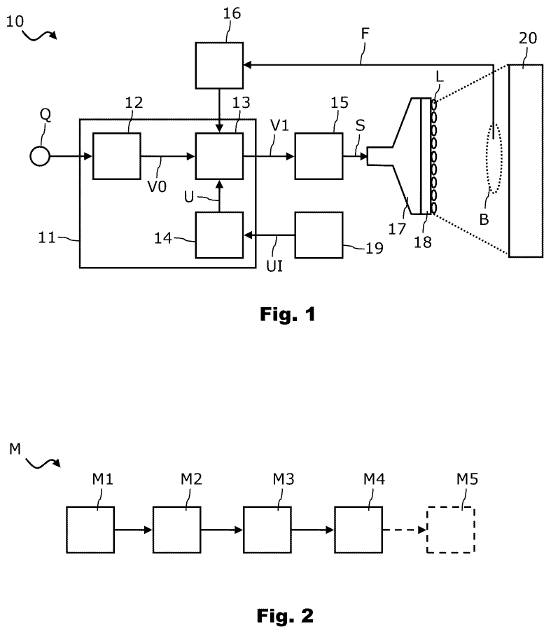

FIG. 1 schematically illustrates a matrix LED spotlight 10 suitable for use in the event, studio, cinema or theatre sector, for example. The matrix LED spotlight 10 has a light-generating assembly 17, which serves to project light onto an illumination surface B of an object 20 to be illuminated. The object 20 to be illuminated may for example be a screen, a theatre stage, a wall, a room or any other suitable object. The illumination surface B on a surface or in the vicinity of the object 20 to be illuminated may have a variable or adjustable size and any desired outline shape.

The light-generating assembly 17 in general has a carrier 18 on which a matrix of light-emitting diodes (LEDs) L is arranged. This matrix may for example have LEDs arranged in one or more rows, lines and/or columns. The LEDs may be of any color, emission intensity and/or size. In particular, LEDs having different light emission characteristics may also be arranged next to one another in the matrix in different areas or portions of the matrix. For example, the LEDs may be combined in multi-colored clusters in which light from neighboring LEDs in each cluster can be mixed together to form a pixel of the desired color by controlling the individual LEDs of different colors or color temperatures. The carrier 18 may for example have one or more PCBs (printed circuit boards) or any other suitable substrate on which the LEDs L can be attached and supplied with power in a targeted manner.

The light-generating assembly 17 may further have a housing and optical elements with which targeted light emission in one direction or at a particular angle is possible. For example, the light-generating assembly may have projection optics by means of which the emitted light of each individual LED can be projected onto objects in the far field without distortion or color errors, such as onto the illumination surface B of the object 20 to be illuminated in an event, studio, cinema or theatre application.

In order to be able to control the LEDs L, the matrix LED spotlight comprises an LED control device 15 which is coupled to the light-generating assembly 17. The LED control device 15 serves to control the matrix of LEDs L individually to emit light. This control takes place on the basis of a matrix-resolved image information stream V1 output by a central processor 13 of a control information generator 11. The central processor 13 is operated with software with the aid of which lighting parameters V0 can be converted into static image information and/or dynamic video information which specifies the lighting behavior or characteristics of the individual LEDs L of the matrix over time. This static image information and/or dynamic video information is subsequently transmitted to the LED control device in the matrix-resolved image information stream V1.

The control information generator 11 has a first input interface 12, for example a DMX interface (“digital multiplex”, DMX), an RDM interface (“remote device management”, RDM), an ArtNet interface or an ACN interface (“architecture for control networks”, ACN). Lighting parameters V0 can be fed in from an image information source Q via the first input interface 12. The lighting parameters V0 may include, for example, a radiation characteristic, a brightness, a brightness gradient, a two-dimensional light distribution shape, a color, a color gradient and/or a color correction. The central processor 13 of the control information generator 11 can use its software to establish a defined assignment or calibration between the lighting parameters V0 on the input side and image/video parameters of the matrix-resolved image information stream V1 on the output side.

In order to make precise, photometrically and colorimetrically correct settings of the light field possible, as is often desired in professional lighting applications in the event, studio, cinema or theatre sector, for example, the control information generator 11 also has a second input interface 14, via which user-generated adjustment commands U can be fed into the central processor 13. For example, the second input interface 14 may be coupled to a user control device 19 outside the control information generator 11, via which a user can make user inputs UI. For example, the user control device 19 may have mechanical control elements such as rotary knobs, joysticks, keyboards, trackballs or the like and/or electronic control elements such as a touchscreen or a touchpad. In addition, the user control device 19 may have display elements that allow the user to record the current state of the control information generator 11 or the currently fed-in lighting parameters V0 in real time or near real time.

The user-generated adjustment commands U are processed by the central processor 13 to adjust the lighting parameters V0 fed in via the first input interface 12 to generate the matrix-resolved image information stream V1. For example, a user can use the user-generated adjustment commands U to set a light distribution resembling a Fresnel lens having a specific half-beam angle and/or a specific illuminance at a given distance. In addition, the user can use the user-generated adjustment commands U to achieve a convenient and practical setting of any light distribution, such as swiveling a light cone by a specific angle in a desired direction, zooming to a desired half-beam angle and/or correcting a light color with selectable digital color filters.

In order to be able to calibrate the matrix-resolved image information stream V1, the light emitted by the light-generating assembly 17 can be detected at or on an illumination surface B of the object 20 to be illuminated. For this purpose, the matrix LED spotlight 10 may for example have a feedback device 16 which is coupled to the control information generator 11. The feedback device 16 detects the light emitted by the light-generating assembly 17 and sends a corresponding feedback signal F to the control information generator 11 for calibrating the matrix-resolved image information stream V1.

FIG. 2 schematically illustrates a flow chart of a method M for controlling a light-generating assembly of a matrix LED spotlight, which has a carrier on which a matrix of light-emitting diodes (LEDs) is arranged. The method M may for example be carried out using the matrix LED spotlight 10 as shown in FIG. 1.

Initially, in a first step M1, lighting parameters V0 are received via a first input interface 12 of a control information generator 11 of the matrix LED spotlight 10. At the same time or within a temporal relationship, in a second step M2, user-generated adjustment commands U for adjusting the lighting parameters V0 fed in via the first input interface 12 are received via a second input interface 14 of the control information generator 11 of the matrix LED spotlight 10.

In a third step, the control information generator 11 converts the adjusted lighting parameters V0 into a matrix-resolved image information stream V1, which is used in a fourth step M4 to control the individual LEDs L of the matrix of LEDs by means of an LED control device 15 to emit light. The matrix-resolved image information stream V1 may have static image information or dynamic video information which specifies the lighting behavior or characteristics of the individual LEDs L of the matrix over time.

Optionally, in a fifth step M5, the light emitted by the light-generating assembly 17 may be detected at or on an illumination surface B of the object 20 to be illuminated. On the basis of the detected light, a feedback signal F is sent to the control information generator 11 in order to be able to calibrate the matrix-resolved image information stream V1.

In the above detailed description, various features are grouped into one or more examples for the purpose of streamlining the disclosure. It will be appreciated that the above description is intended to be illustrative, and not restrictive. It is intended to cover all alternatives, modifications, and equivalents. Many other examples will be apparent to one skilled in the art upon consideration of the above description.

The embodiments have been chosen and described so as best to explain the principles behind the invention and its practical applications, and thus to allow others skilled in the art to make the best possible use of the invention and various embodiments with various modifications suited to the particular use under consideration. In the accompanying claims and the description, the terms “including” and “in which” are used as simple-language counterparts for the terms “comprising” and “wherein” respectively. Furthermore, “a” or “an” as used herein does not exclude the possibility of a plurality.

What is claimed is:

1. A matrix light-emitting diodes (LED) spotlight, comprising:
a light-generating assembly comprising a carrier on which a matrix of LEDs is arranged;
an LED control device which is coupled to the light-generating assembly and is designed to control the matrix of LEDs individually to emit light on the basis of a matrix-resolved image information stream; and
a control information generator which is coupled to the LED control device and which has a first input interface for feeding in lighting parameters and a second input interface for feeding in user-generated adjustment commands for adjusting lighting parameters fed in via the first input interface for generating the matrix-resolved image information stream.

2. The matrix LED spotlight of claim 1, further comprising:
a feedback device which is coupled to the control information generator and is designed to detect the light emitted by the light-generating assembly and, on the basis of the detected light, to send a feedback signal to the control information generator for calibrating the matrix-resolved image information stream.

3. The matrix LED spotlight of claim 1, wherein the matrix-resolved image information stream comprises static image information or dynamic video information which specifies the lighting behavior of the individual LEDs of the matrix over time.

4. The matrix LED spotlight of claim 1, wherein the first input interface is at least one of: a DMX interface, an RDM interface, an ArtNet interface and an ACN interface.

5. The matrix LED spotlight of claim 1, further comprising:
a user control device which is coupled to the control information generator via the second input interface and has at least one of mechanical and electronic operating elements for a user.

6. The matrix LED spotlight of claim 1, wherein the lighting parameters include at least one of: a radiation characteristic, a brightness, a brightness gradient, a two-dimensional light distribution shape, a color, a color gradient and a color correction.

7. The matrix LED spotlight of claim 1, wherein the light-generating assembly further comprises projection optics designed to project the emitted light of each individual LED onto objects in the far field without distortion and color errors.

8. A method for controlling a light-generating assembly of a matrix light-emitting diodes (LED) spotlight, which has a carrier on which a matrix of LEDs is arranged, the method comprising the steps of:
receiving lighting parameters via a first input interface of a control information generator;
receiving user-generated adjustment commands for adjusting the lighting parameters fed in via the first input interface via a second input interface of the control information generator;
converting the adjusted lighting parameters by the control information generator into a matrix-resolved image information stream; and
controlling the individual LEDs of the matrix of LEDs by means of an LED control device to emit light on the basis of the matrix-resolved image information stream.

9. The method according to claim 8, further comprising the step of:
detecting the light emitted by the light-generating assembly and sending a feedback signal for calibrating the matrix-resolved image information stream to the control information generator on the basis of the detected light.

10. The method according to claim 8, wherein the matrix-resolved image information stream comprises static image information or dynamic video information, which specifies the lighting behavior of the individual LEDs of the matrix over time.
